(19) United States
(12) Patent Application Publication
(10) Pub. No.: US 2008/0007565 A1
(43) Pub. Date: Jan. 10, 2008

(54) Color correction circuit, driving device, and display device

(76) Inventors: Shinichi Nogawa, Chiba-shi (JP); Kenichi Matsushima, Chiba-shi (JP)

Correspondence Address: BRUCE L. ADAMS, ESQ., SUITE 1231, 17 BATTERY PLACE, NEW YORK, NY, 10004, US

(21) Appl. No.: 11/824,874

(22) Filed: Jul. 2, 2007

(30) Foreign Application Priority Data
Jul. 3, 2006 (JP) 2006-183427
Jan. 31, 2007 (JP) 2007-021317

(51) Int. Cl. G09G 5/02

(52) U.S. Cl. 345/597

(57) ABSTRACT

When image data of R, G, and B is converted into linear data by a pre-gamma circuit, the number of bits of the image data is increased to improve the resolution thereof and then the image data is processed by a matrix operator. A result obtained by matrix operation is subjected to data conversion by a post-gamma circuit and stored in an image RAM. A dither circuit is provided between the post-gamma circuit and the image RAM and gradation unevenness or color unevenness is eliminated by area gradation processing using the dither circuit. A color variation of each display device is stored in a PROM as a fine adjustment coefficient for the matrix operator to realize a display device having no color variation. A display device is realized in which the plurality of color correction modes can be set by simple switching.

### BACKGROUND OF THE INVENTION

1. Field of the Invention

The present invention relates to a color correction circuit for converting numerical values of R, G, and B with a matrix operation circuit in order to adjust a color tone of an image displayed on a device for performing color display based on a luminance of each colors R, G, and B.

2. Description of the Related Art

In recent years, there are increasing opportunities to display a picture image obtained by a camera on a monitor of a personal computer or to print the picture image by a printer. The sRGB color space format is generally used to reproduce the image with the same colors. Since an output image of the camera is adjusted to the sRGB format and the monitor output of the personal computer and the printer output are also adjusted to the sRGB format, the colors of output images are identical to each other. A color display device should be adjusted to display an input image data in the sRGB format with desired colors.

FIG. 2 shows a general flow for image data. Image data obtained by a camera 200 is sent to a control section 210. The control section 210 stores the image data into a memory 220 and reads the image data from the memory 220 to send the data to a printer 230 or to a liquid crystal display (herein after abbreviated as LCD) device 240. Color standards are thus determined to the image data so that colors of the image data obtained by the camera are identical to output colors of the printer 230 or the LCD device 240, and the sRGB format is generally used in many cases. The LCD device 240 receives the image data of the sRGB format, adjusts a driving characteristic of an LCD driver to display the desired colors, and converts numerical values of the image data by calculating the data for R, G, and B with a matrix operation circuit. FIG. 3 is a block diagram showing an LCD driving IC 300 to which a color correction circuit using a matrix operation is included. Input image data from an interface section 310 is stored in an image RAM 330 through a color correction circuit 320. A display output of an LCD panel 350 is enabled by a driving signal sent from an LCD driving circuit 340. FIG. 4 is a block diagram showing the general color correction circuit 320. The color correction circuit 320 includes a pre-gamma circuit 410, a matrix operation circuit 420, and a post-gamma circuit 430. The pre-gamma circuit 410 calculates the 2.2th power of sRGB image data to convert numerical values of R, G, and B into data having linear characteristics. Calculating the 0.45th power of the result obtained by operation to the data having linear characteristics, the post-gamma circuit 430 brings the linear data back to data having nonlinear characteristics which is similar to the original sRGB image data, and stores the data into the image RAM 330.

There is also a case where an output of the post-gamma circuit is directly connected to the LCD driving circuit without passing through the RAM. In this case, the post-gamma circuit is provided with an inverse gamma characteristic for LCD to perform data conversion (see JP 2002-232905 A).

In the calculation of the sRGB image data using the color correction circuit, there is a case where the 2.2th power conversion of the pre-gamma circuit, the precision of the matrix operation, the 0.45th power conversion of the post-gamma circuit, or the like leads to a shortage in resolution, causing unevenness in gradation or color due to bit error. In particular, when the number of colors of the image data is small as in the case of, for example, 260k (i.e., 262144 colors) in which 6 bits for each of R, G, and B or 65k (i.e., 65536 colors) in which 5 bits for R, 6 bits for G and 5 bits for B, the influence of the bit error is large, resulting in the clear observation of the unevenness in gradation or color. In addition, there is a problem that tendency in color varies in each display device.

When the matrix operation is performed in a display device so as to obtain colors suitable for sRGB, there is a case where a result obtained by color correction narrows an original color representation range (color gamut; also referred to as an NTSC ratio) of the display device. FIG. 14 shows an example thereof. When a color display ability (LCD gamut) of a display device such as an LCD exceeds an sRGB color display ability (sRGB gamut), the color correction calculation narrows the color representation range of the display device due to original absence in necessity to display a color space outside the sRGB gamut.

In this case, as shown in FIG. 15, use of a method of adjusting only an achromatic color such as white (W) to the sRGB gamut does not narrow the color reproduction range of the display device. However, no means is provided in which the method can be easily applied by a user.

### SUMMARY OF THE INVENTION

In order to solve the above-mentioned problems, according to the present invention, the following means are employed.

(1) A color correction circuit for adjusting a color tone on a display device for performing color display based on a luminance of each colors R, G, and B, includes: a pre-gamma circuit for converting numerical values of the R, G, and B; a matrix operation circuit for performing an operation using numerical values from the pre-gamma circuit; and a post-gamma circuit for converting numerical values from the matrix operation circuit. The pre-gamma circuit converts the numerical values of the R, G, and B into linear data. The post-gamma circuit converts the numerical values from the matrix operation circuit into nonlinear data. The number of bits for the numerical values from the pre-gamma circuit is made larger than the number of bits for the numerical values of each of the R. G, and B input to the pre-gamma circuit to increase resolution.

(2) A color correction circuit for adjusting a color tone of a display device for performing color display based on a luminance of each colors R, G, and B. includes: a pre-gamma circuit for converting numerical values of the colors R, G, and B; a matrix operation circuit for performing an operation using numerical values from the pre-gamma circuit; and a post-gamma circuit for converting numerical values from the matrix operation circuit. The number of bits for the numerical values from the pre-gamma circuit is increased to a value larger than the number of bits of the numerical value of each of the colors R, G, and B input in a range of two bits to four bits to increase a resolution.

(3) A color correction circuit for adjusting a color tone of a display device for performing color display based on a luminance of each colors R, G, and B, includes: a pre-gamma circuit for converting numerical values of the A, G. and a colors; a matrix operation circuit for performing an operation using numerical values from the pre-gamma circuit; and a post-gamma circuit for converting numerical values from the matrix operation circuit. An average color correction coefficient for the display device and a fine adjustment coefficient for finely adjusting a color variation of each display device are separately set. A result obtained by adding the respective coefficients to each other is set as a calculation coefficient for the matrix operation circuit.

(4) A color correction circuit for adjusting a color tone of a display device for performing color display based on a luminance of each colors R, G, and B, includes; a pre-gamma circuit for converting numerical values of the colors R, G, and B; a matrix operation circuit for performing a calculation using numerical value from the pre-gamma circuit; and a post-gamma circuit for converting numerical values from the matrix operation circuit. Each color correction coefficient for the display device is stored in a PROM as a calculation coefficient for the matrix operation circuit.

(5) In the color correction circuit of the present invention, a color correction mode (hereinafter referred to as mode 1) for original sRGB color representation and a color correction mode (hereinafter referred to as mode 2) for adjusting only an achromatic color such as white to an sRGB color can be used as a mode for a matrix operator. The mode 1 and the mode 2 are switched therebetween by an operation of a user.

According to the present invention, when, for example, the 2.2th power of sRGB image data is to be obtained by the pre-gamma circuit to converted into linear data, the number of bits of the image data is increased to a value larger than each of input R, G, and B values in a range of two bits to four bits to increase the resolution. The matrix operation unit performed high-precision operation using the image data whose resolution is high. For example, the number of bits of the image data is converted into the number of bits larger than the number of bits required for the image RAM by the 0.45th power conversion of the post-gamma circuit. The image data obtained after color correction is written into the image RAM through the dither circuit.

Accordingly, even when the number of colors of the image data is small, no gradation unevenness or color unevenness is caused by a bit error in the color correction operation.

The fine adjustment coefficient for adjusting a color variation of each display device is stored in the PROM as an operation coefficient for the matrix operation unit (coefficient for color correction). Therefore, a display device having no color variation can be realized.

The faithful sRGB color representation and the representation of color to some extent closer to the sRGB color in a state in which a color area of the display device is maintained can be selected by switching between the mode 1 and the mode 2. The mode 1 and the mode 2 are instantaneously switched therebetween by circuits, so the mode 1 and the mode 2 can be easily selected according to user preferences.

### BRIEF DESCRIPTION OF THE DRAWINGS

In the accompanying drawings:

FIG. 1 shows a color correction circuit according to an embodiment of the present invention;

FIG. 2 shows a general flow for image data;

FIG. 3 is a block diagram showing an LCD driving IC to which a color correction circuit using a matrix operation is included;

FIG. 4 is a block diagram showing a general color correction circuit;

FIG. 5 is an explanatory diagram showing an operation of a dither circuit;

FIG. 6 is an explanatory diagram showing the operation of the dither circuit;

FIG. 7 is an explanatory diagram showing an example of providing a color correction coefficient to a matrix operation unit;

FIG. 8 is an explanatory diagram showing another example of providing the color correction coefficient to the matrix operation unit;

FIG. 9 shows color correction coefficients and a circuit structure of the matrix operation unit;

FIG. 10 shows a matrix operation expression for mode 1;

FIG. 11 shows a matrix operation expression for mode 2;

FIG. 12 is a circuit structure diagram showing a circuit for realizing the mode 2 (part 1);

FIG. 13 is a circuit structure diagram showing a circuit for realizing the mode 2 (part 2);

FIG. 14 is a color gamut for color correction suitable for sRGB colors;

FIG. 15 is a color gamut for adjusting only an achromatic color such as white to a sRGB gamut; and

FIGS. 16A and 16B show display devices according to the embodiment of the present invention.

### DETAILED DESCRIPTION OF THE PREFERRED EMBODIMENT

Hereinafter, the present invention will be described by way of embodiments.

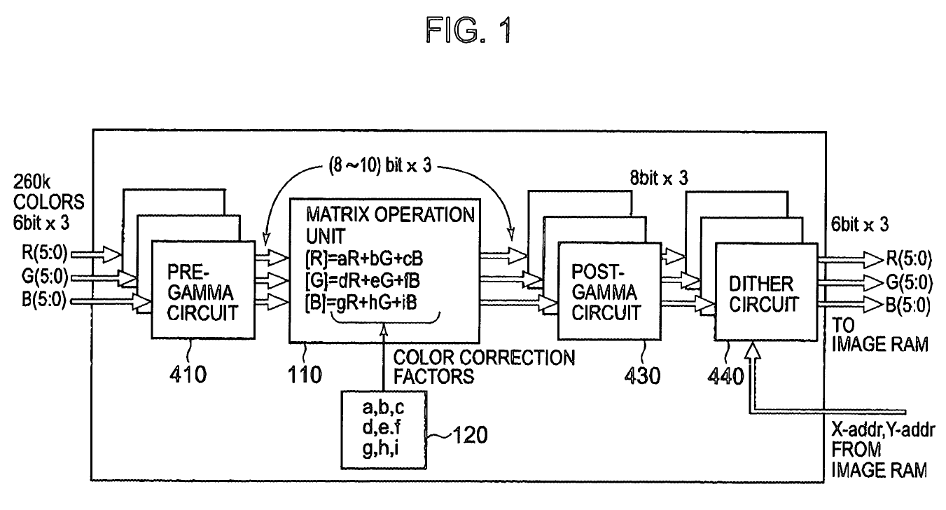

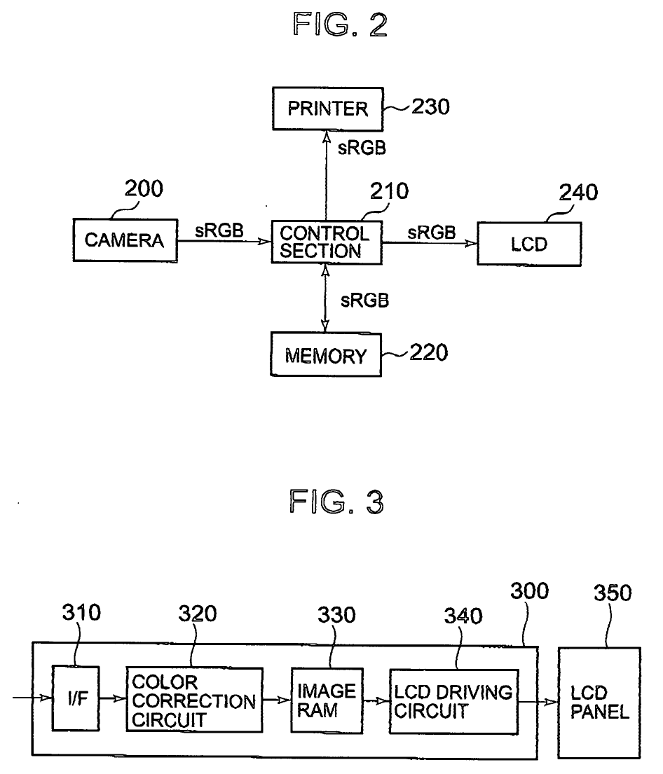

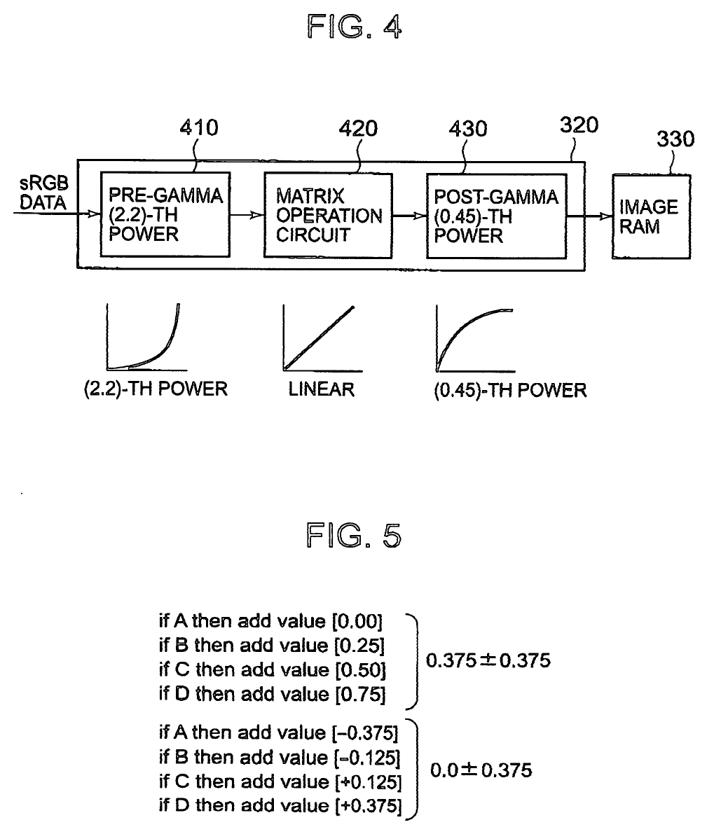

FIG. 1 shows a color correction circuit according to the embodiment of the present invention. It is assumed that image data of an sRGB format has 260k colors (=262144 colors) and the number of bits for R, G, and B is 6 each. Calculation of the 2.2th power of the image data by a pre-gamma circuit 410 causes reduction of resolution in a region where the original data has small numerical values, requiring the number of bits for converted data to be larger than the number of bits for the original data. An excessive increase of the number of bits is not desirable since the increase in the number of bits leads to an increase of matrix operation circuit. Experimental results show that the number of bits for converted data should be larger than those for the input RGB data by two or more bits to solve the problem, and that increase in the number of bits in a range of two to four bits is desirable in view of function and circuit scale. When the number of bite for each of R, G, and B of the image data is 6, the number of bits for each of R, G, and B is increased in a range of eight to ten bits. For example, when six bits for each of X, G, and B of the image data is to be increased to eight bits, the 2.2th power of each of values of six bits (0 to 63) for each of R, G, and B is calculated and calculated values are adjusted such that the maximum value in the calculated values becomes 255, thereby converting the values of the six bits into numerical values of eight bits (0 to 255) for each of R, G, and B.

A matrix operator 110 performs a 3×3 matrix product and sum operation based on Expression 1 using the 2.2th power of a value of each of R, G, and B color correction coefficients 120 (a, b, c, d, e, f, g, h, i).
[R]=aR+bG+cB
[G]=dR+eG+fB
[B]=gR+hG+iB (Expression 1)

For example, it is assumed that the value of each of R, G, and B received by the matrix operator is eight bits and each of the color correction coefficients is eight bits, a result obtained by the operation becomes 16 bits. The result obtained by the matrix operation is converted into data corresponding to the 0.45th power thereof by a post-gamma circuit 430 and the data is stored in an image RAM as original sRGB color space format data. However, the scale of the post-gamma circuit becomes excessively large if the input data to the post-gamma circuit has 16 or more bits corresponding to the matrix operation without any change. It is therefore desirable to reduce the number of bits to the minimum with which image quality is not deteriorated.

Experimental results show that in the case where the number of bits for each of R, G, and B of the image data is 6, the number of bits for each of R, G, and B of the input date to the post-gamma circuit should be in the range of eight to ten to obtain necessary gradation level.

The post-gamma circuit 430 calculates the 0.45th power of the result obtained by the matrix operation, makes the number of bits equal to that of the original image data, and stores the calculated result into the image RAM.

In the case of 260k colors, the post-gamma circuit receives a result obtained by operation in a range of eight bits to ten bits in each of R, G, and B from the matrix operation circuit, and converts the received result into data of six bits of each of R, G, and B and stores the data into the image RAM. When the number of colors of the original image data is as small as 260k, the 2.2th power data conversion in the pre-gamma circuit or the 0.45th power data conversion in the post-gamma circuit may lead to a partial reduction in resolution, or a rounding error of the matrix operation causes slight in gradation or color on an image obtained after color correction conversion.

In order to prevent the abovementioned unevenness, a dither circuit 440 is provided between the post-gamma circuit and the image RAM.

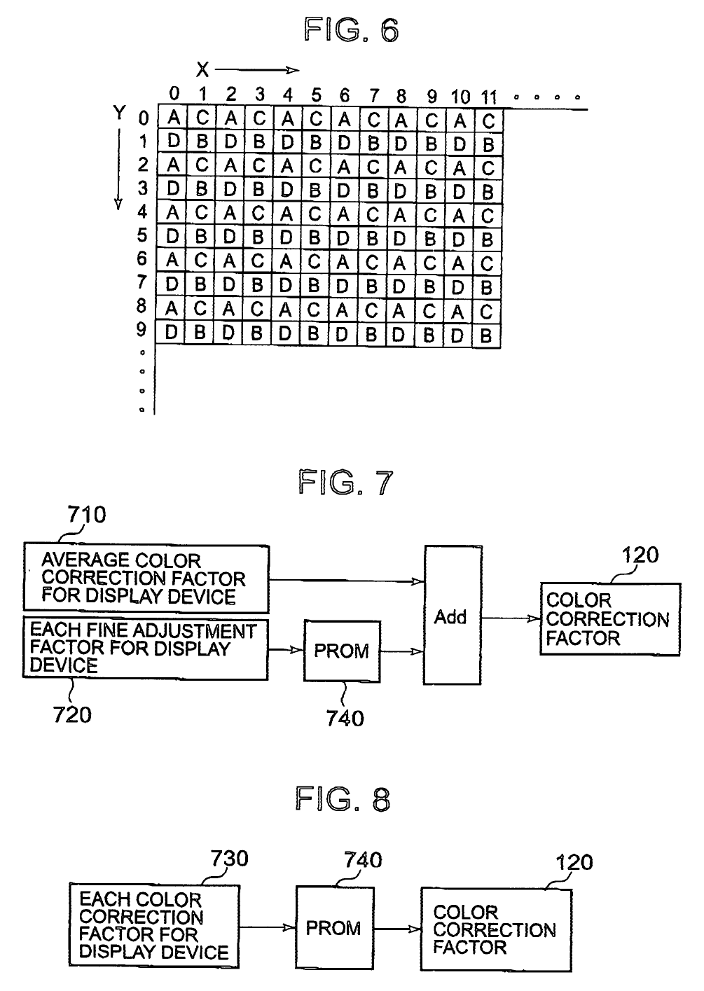

FIGS. 5 and 6 are explanatory diagrams showing the operation of the dither circuit. Area gradation is applied to a display plane of the image RAM.

FIG. 6 shows an example of 2×2 dithering. An area of the image RAM is divided into 2×2 groups in an x-direction and a y-direction at every two addresses. As shown in FIG. 6, labels A, B, C, and D are regularly assigned to each of the groups and a small offset value is added to each of image data values according to the label before storage. Fractions 0/4, ¼, 2/4, or ¾ are added to each of the image data values respectively according to the label and the only integer part of the data is taken in order to perform dithering on the least significant bit (LSB), permitting pseudo gradation representation corresponding to decimal fraction values before dithering.

As shown in the upper portion of FIG. 5, the number of bits of the data from the post-gamma circuit has two bits more than the number of bits of data to be stored in the image RAM. 0 (zero) is added to a pixel labeled A, 0.25 to a pixel labeled B, 0.5 to a pixel labeled C, and 0.75 to a pixel labeled D. Accordingly the number of colors represented by the display device can be quadrupled. The unevenness in gradation or color which is caused by an insufficient color representation capacity of 260k colors is dispersed through area gradation, suppressing incongruity of a viewer looking through his/her eyes.

Since addition of offset values of 0, +0.25, +0.5, and +0.75 to the pixels labeled A, B, C, and D, respectively, increases an average intensity of the image by 0.5×LSB, as shown in a lower portion of FIG. 5, it is actually desirable to use offset values of −0.375, −0.125, +0.125, and +0.375, which can prevent a change in intensity of the image, even when the dithering is turned ON/OFF. The dithering has been described in the case of 260k colors. Even in the case of 65k colors (five bits for R, six bits for G, and five bits for B), the same processing can give a large effect. In addition, 4×4 dithering can be performed to obtain a larger effect. The number of bits for the data from the post-gamma circuit has four bits more than the number of bits for the data to be stored in the image RAM, and 16 labels for area gradation are assigned in a partition to add 0/16 to 15/16 to each labels.

FIG. 7 shows how a color correction coefficient 120 is given to the matrix operator. Each of nine color correction coefficients (a, b, c, d, e, f, g, h, i) can be arbitrarily given as an average color correction coefficient for the display device by a controller. In this embodiment, fine adjustment coefficients for correcting a color variation of each display device are separately kept in addition to the average color correction coefficients for the display devices and the sum of both coefficients (added values) is transferred to the operator as coefficients for the matrix. In an actual manufacturing process, coefficients of a color variation component of each display device are obtained at the stage of the assembly test of the display device and stored as each fine adjustment coefficients 720 for the display device in a nonvolatile memory 740. In the case where an image is to be displayed, when the matrix operation is performed using coefficients obtained by adding the average color correction coefficients 710 for the display device and fine adjustment coefficients 720 for each display devices which are stored in the nonvolatile memory 740, the color variation of each display device is suppressed and desired sRGB colors can be displayed. Storage of only the fine adjustment coefficients in the nonvolatile memory 740 can reduce a necessary memory capacity.

There is an alternative method of transferring the color correction coefficients as the matrix coefficient to the operator. As shown in FIG. 8, in the assembly test of each display device, each color correction coefficient 730 for the display device is separately obtained and stored in the nonvolatile memory such as PROM 740. When the matrix operation is performed using the stored coefficient, colors suitable for each display device can be displayed.

In the above-mentioned example, a semiconductor memory such as a PROM, an EPROM, or an EEPROM, an FeRAM made from a ferroelectric material or an MRAM from a magnetic material, or the like can be used as the nonvolatile memory for storing each fine adjustment coefficient 720 for the display device and each color correction coefficient 730 for the display device.

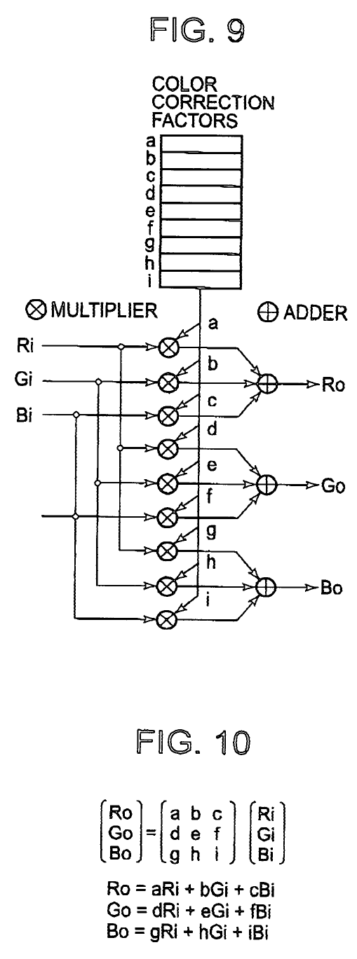

As shown in FIG. 9, the nine color correction coefficients (a, b, c, d, e, f, g, h, i) are supplied to nine corresponding multipliers included in the matrix operator. Nine calculated results are added for each group including three results to generate respective RGB outputs (Ro, Go, Bo).

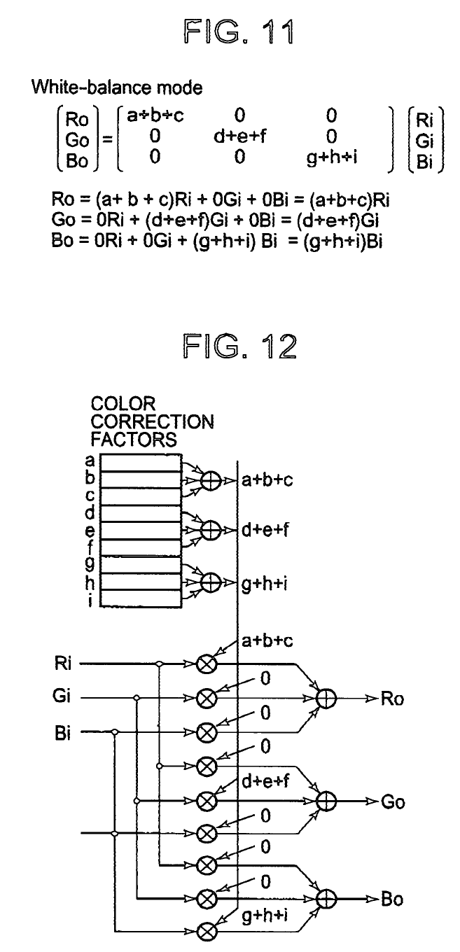

FIG. 10 shows a matrix equation for the function of the matrix operator shown in FIG. 9. In the matrix presentation of the nine color correction coefficients (a, b, c, d, e, f, g, h, i) shown in FIG. 10, setting zero to the non-diagonal coefficients (b, c, d, f, g, h) and (a+b+c, d+e+f, g+h+i) to the diagonal coefficients (a, e, i), a white balance mode (mode 2) expressed by an equation shown in FIG. 11 is obtained.

Applicability of the color correction circuit according to the present invention to the mode 2 permits selection of the representation of colors close to sRGB colors while maintaining the gamut of the display device at the maximum if desired by a user. In the actual setting of the mode 2, correction coefficients for color variation to each display device, which is stored in the nonvolatile memory, is read and added to the average color correction coefficients for the display device to obtain the nine color correction coefficients (a, b, c, d, e, f, g, h, i). The diagonal coefficients (a+b+c, d+e+f, g+h+i) are then obtained and set as shown in FIG. 11.

When the above-mentioned setting is performed by a user, the mode 2 can be selected. However, reading out from the nonvolatile memory or adding coefficient for resetting is a relatively complicated operation. Therefore, in order to solve this, a circuit shown in FIG. 12 is provided.

The color correction coefficient obtained by adding the color variation correction coefficient for each display device and the average color correction coefficient for the display device which are stored in the nonvolatile memory is prepared in advance so as to be transferred as the matrix coefficient to the operator. As shown in FIG. 12, color correction coefficients (a, b, c), (d, e, f), and (g, h, i) are added by adders respectively, and a reconnected to three multipliers. Putting zero to each of six multipliers other than the three multipliers completes the setting of the mode 2.

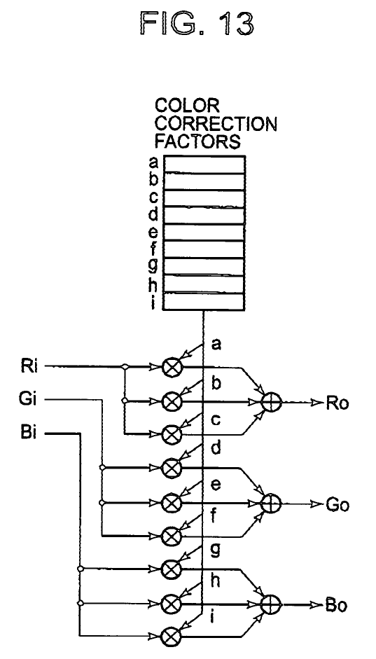

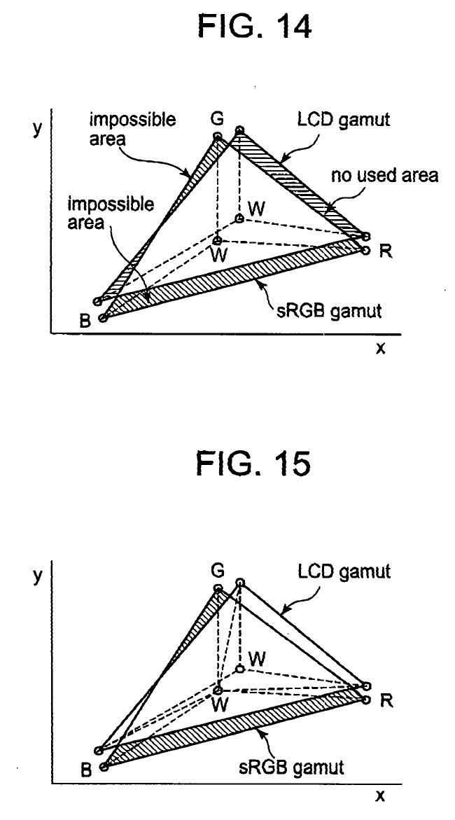

Alternatively, as shown in FIG. 13, the nine color correction coefficients (a, b, c, d, e, f, g, h, i) are held connected to nine multipliers and the switching among connection ports for color input to the nine multipliers enables the setting of the mode 2.

The operation for operating the adders for the color correction coefficients as shown in FIG. 12 and the operation for switching among the connection ports for color input as shown in FIG. 13 are instantaneously switched therebetween based on mode set information from a user. The user only decides a mode to be used, and no complicated action is necessary.

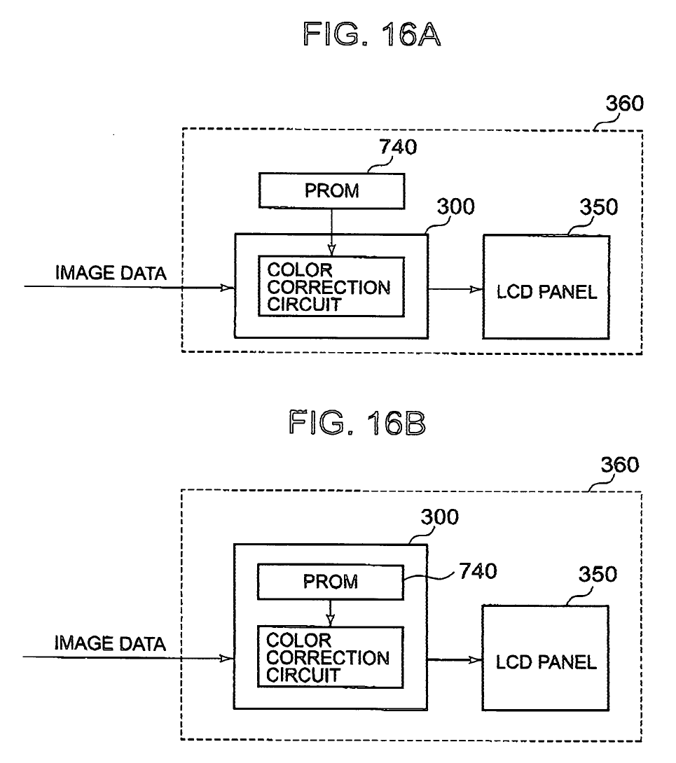

FIGS. 16A and 16B show display devices using the color correction circuit according to the embodiment of the present invention. FIG. 16A shows a case where the nonvolatile memory 740 for storing each fine adjustment coefficient 720 for the display device and each color correction coefficient 730 for the display device is separated from an LCD driving device 300 and incorporated in a display device 360. FIG. 16B shows the display device 360 in which the LCD driving device 300 includes the nonvolatile memory 740. As shown in FIGS. 16A and 16B, the nonvolatile memory 740 may be located inside or outside the LCD driving device 300. In the case where the nonvolatile memory 740 is located outside the LCD driving device 300, mounting both the nonvolatile memory IC and the LCD driving device on the display device 360 can complete the embodiment of the present invention.

What is claimed is:

1. A color correction circuit for adjusting a color tone on a display device for performing color display based on a luminance of each colors R, G, and B, comprising:
a pre-gamma circuit for converting input numerical values of the R, G, and B into linear data;
a matrix operation circuit for performing an operation using numerical values from the pre-gamma circuit; and
a post-gamma circuit for converting numerical values from the matrix operation circuit into nonlinear data,
wherein a number of bits of the numerical values from the pre-gamma circuit is made larger than a number of bits of the input numerical values of each of the R, G, and B to increase a resolution.

2. A color correction circuit according to claim 1, wherein the number of bits of the numerical values from the pre -gamma circuit is larger than the number of bits of the input numerical values of each of the R, G, and B in a range of two to four bits.

3. A color correction circuit according to claim 1, wherein:
the color correction circuit has average color correction coefficients for the display device and fine adjustment coefficients for finely adjusting a color variation of each display device; and
operation coefficients for the matrix operation circuit are obtained by adding the average color correction coefficients and the fine adjustment coefficients.

4. A color correction circuit according to claim 3, wherein the fine adjustment coefficients are stored in a nonvolatile memory.

5. A color correction circuit according to claim 1, wherein each color correction coefficients for the display device are stored in a nonvolatile memory as operation coefficients for the matrix operation circuit.

6. A color correction circuit according to claim 1, wherein an output of the post-gamma circuit is connected with an image RAM.

7. A color correction circuit according to claim 1, further comprising a dither circuit located in a subsequent stage of the post-gamma circuit, for sending a result obtained by dithering to the image RAM.

8. A color correction circuit according to claim 7, wherein the dither circuit increases the number of bits of the output of the post-gamma circuit to a value larger than the number of bits to be sent to the image RAM by two bits to perform the dithering on 2×2 pixels.

9. A color correction circuit according to claim 7, wherein the dither circuit increases the number of bits of the output of the post-gamma circuit to a value larger than the number of bits to be sent to the image RAM by four bits to perform the dithering on 4×4 pixels.

10. A color correction circuit according to claim 1, wherein the matrix operation circuit includes color correction modes including an sRGB mode for original sRGB color representation and a white-balance mode for adjusting only an achromatic color to an sRGB color.

11. A color correction circuit according to claim 10, wherein in the white-balance mode, a result obtained by adding three color correction coefficients for each of A, C, and B by an adder is set as an operation coefficient for the matrix operation circuit.

12. A color correction circuit according to claim 10, wherein color inputs to nine multipliers comprising the matrix operation circuit are switched to prevent color mixing in the white-balance mode.

13. A driving device, comprising the color correction circuit according to claim 1.

14. A display device, comprising:
a driving device including the color correction circuit according to claim 1; and
an LCD panel connected to the driving device.
